(19) United States
(12) Patent Application Publication
(10) Pub. No.: US 2025/0061508 A1
(43) Pub. Date: Feb. 20, 2025

(54) METHOD AND APPARATUS FOR PROVIDING PRODUCT OBJECT INFORMATION

(71) Applicant: Hangzhou Alibaba International Internet Industry Co., Ltd., Hangzhou (CN)

(72) Inventor: Lei ZHANG, Hangzhou (CN)

(21) Appl. No.: 18/796,656

(22) Filed: Aug. 7, 2024

(30) Foreign Application Priority Data
Aug. 16, 2023 (CN) 202311038842.1

(51) Int. Cl. G06Q 30/0601

(52) U.S. Cl. CPC G06Q 30/0641

(57) ABSTRACT

Embodiments of the application present a method and electronic device for providing product object information. The method includes: identifying at least one target product object and its original descriptive information to be provided to a target user; determining national or regional attribute information of the target user; processing the original descriptive information to adapt to local expression based on the target user's national or regional attribute information to generate target descriptive information; and providing the target descriptive information corresponding to the at least one target product object to a client device of the target user to provide the target descriptive information on a designated webpage. These embodiments enable the expression of product object information on the designated webpage to achieve a “customized experience for each individual”, enhancing user experience and potentially increasing click-through rates and conversion rates.

### CROSS-REFERENCE TO RELATED APPLICATIONS

This application claims priority to Chinese Patent Application No. 202311038842.1, filed with the China National Intellectual Property Administration on Aug. 16, 2023, and entitled “METHOD AND APPARATUS FOR PROVIDING PRODUCT OBJECT INFORMATION”, which is incorporated herein by reference in its entirety.

### TECHNICAL FIELD

The application relates to the field of information technology, specifically to a method for providing product object information and electronic devices.

### BACKGROUND

In product information service systems, “customized experience for each individual” typically refers to the strategy of tailoring different product recommendations for different consumers to achieve better sales outcomes. Traditional product recommendations are based on the attributes of the products themselves, such as category, price, sales volume, and other factors. In contrast, “personalized recommendations” are consumer-based, recommending products based on factors such as the consumer's interests, purchase history, and behavior.

This “customized experience for each individual” approach has a positive effect on improving product click-through rates, conversion rates, and other metrics. However, how to further enhance user experience and improve metrics such as click-through rates and conversion rates remains a key focus for professionals in this field.

### SUMMARY

Embodiments of this application provide a method for providing product object information and an electronic device, enabling the realization of “customized experience for each individual” in the expression of front-end descriptive information of product objects on the target webpage. This enhances user experience and helps improve metrics such as click-through rates and conversion rates.

The application offers the following solutions:

a method for providing product object information, including:
identifying at least one target product object and its original descriptive information to be provided to a target user;
determining national or regional attribute information of the target user;
processing the original descriptive information to adapt to local expression based on the target user's national or regional attribute information to generate target descriptive information;
providing the target descriptive information corresponding to the at least one target product object to a client device of the target user to provide the target descriptive information on a designated webpage.

In the application, the processing the original descriptive information to adapt to the local expression based on the target user's national or regional attribute information to generate the target descriptive information includes:
utilizing an artificial intelligence (AI) large-scale parameter model to comprehend the original descriptive information, and processing the original descriptive information to adapt to the local expression based on the national or regional attribute information of the target user to generate the target descriptive information.

In the application, the target product object is associated with multiple Stock Keeping Units (SKUs);

the processing the original descriptive information to adapt to the local expression based on the target user's national or regional attribute information to generate the target descriptive information includes:
processing the original descriptive information corresponding to the SKUs to adapt to local expression to generate the target descriptive information, thereby to provide different target descriptive information for the same SKU to users with different national or regional attribute information, based on various local expression.

In the application, the original descriptive information includes: the original textual content of the target product object;

the processing the original descriptive information to adapt to the local expression based on the target user's national or regional attribute information to generate the target descriptive information includes:
transforming the original textual content of the target product object based on the national or regional attribute information of the target user to adapt to the local expression to generate target textual content, for display on the designated webpage.

In the application, the transforming the original textual content of the target product object based on the national or regional attribute information of the target user to adapt to the local expression includes:
converting keywords related to a product name and/or adjectives included in the original textual content into local common terms corresponding to the national or regional attribute information.

In the application, the original textual content includes: original title textual content;

the transforming the original textual content of the target product object based on the national or regional attribute information of the target user to adapt to the local expression also includes:
processing the original title textual content to adapt to a textual content related to an expression of product attributes based on attribute preferences of a demographic corresponding to the national or regional attribute information for an category of products to which the target product object belongs.

In the application, the processing the original title textual content to adapt to a textual content related to an expression of product attributes includes:
deleting or converting the target textual content related to product attribute expression included in the original title textual content to other attribute values, or adding textual content related to product attribute expression to the original title textual content.

In the application, the original textual content includes: the original user review textual content;

the transforming the original textual content of the target product object based on the national or regional attribute information of the target user to adapt to the local expression further includes:
reordering the original user review textual content based on the national or regional attribute information of the target user, in order to prioritize the display of local user reviews according to the national or regional attribute information.

In the application, the transforming the original textual content of the target product object based on the national or regional attribute information of the target user to adapt to the local expression includes:
Inputting the original textual content and the national or regional attribute information of the target user into an AI large-scale parameter model, so that the AI large-scale parameter model performs the transforming the original textual content of the target product object based on the nationalized or regionalized attribute information of the target user to adapt to into the local expression;
the AI large-scale parameter model is also used to adapt an transformed textual content to conform to local grammatical expression and/or local contextual coherence style based on the local expression corresponding to the national or regional attribute information, to generate the target textual content.

In the application, the information input into the AI large-scale parameter model further includes: a pre-established knowledge base and/or rules. The knowledge base includes local common terms, attribute preference information, and/or knowledge of local grammatical expressions corresponding to multiple local expression in certain countries/regions.

In the application, the original descriptive information includes: the original attribute/parameter description of the target product object;
performing localization-based processing on the original descriptive information to generate the target descriptive information, including;
transforming the original attribute/parameter description of the target product object based on the national or regional attribute information of the target user to adapt to the local expression to generate target attribute/parameter description, for display on a designated webpage.

In the application, the transforming the original attribute/parameter description of the target product object based on the national or regional attribute information of the target user to adapt to the local expression includes:
transforming the original attribute/parameter description of the target product object into commonly used local standards or units based on the national or regional attribute information of the target user.

In the application, the transforming the original attribute/parameter description of the target product object based on the national or regional attribute information of the target user to adapt to the local expression includes:

If the target product object is associated with multiple Stock Keeping Units (SKUs) having different attribute values/parameter values, reordering the SKUs to prioritize the display of the SKUs with the attribute values/parameter values commonly used in the localization corresponding to the national or regional attribute information.

In the application, the transforming the original attribute/parameter description of the target product object based on the national or regional attribute information of the target user to adapt to the local expression includes:
inputting the original attribute/parameter description and the national or regional attribute information of the target user into an AI large-scale parameter model, so that the AI large-scale parameter model performs the transforming the original attribute/parameter description of the target product object based on the nationalized or regionalized attribute information of the target user to adapt to into the local expression.

In the application, the original descriptive information includes: original rich media information of the target product object;

the processing the original descriptive information to adapt to the local expression based on the target user's national or regional attribute information to generate the target descriptive information, includes:
transforming the original rich media information of the target product object based on the national or regional attribute information of the target user to adapt to the local expression to generate target rich media information, for display on the designated webpage.

In the application, the original rich media information includes original image information;

the transforming the original rich media information of the target product object based on the national or regional attribute information of the target user to adapt to the local expression includes:
transforming composition style, model type, and/or atmospheric elements of the original image information based on the national or regional attribute information of the target user to generate target image information that aligns with the local preferences corresponding to the national or regional attribute information.

In the application, the method further includes inputting the original image information and the national or regional attribute information of the target user into the AI large-scale parameter model, so that the AI large-scale parameter model can transform the composition style, model type, and/or atmospheric elements of the original image information.

In the application, when transforming the model type of the original image information, the method further includes determining whether to perform the transforming the model type based on the attribute/parameter information of the target product object.

In the application, the original rich media information includes original audio information;

The transforming the original rich media information of the target product object based on the national or regional attribute information of the target user to adapt to the local expression includes:
transforming the original audio information based on the national or regional attribute information of the target user to generate target audio information that aligns with the local preferences corresponding to the national or regional attribute information.

A method for providing product object information, includes:

Receiving target descriptive information of at least one target product object provided for a target user from a server, the target descriptive information is generated by transforming original descriptive information of the target product object based on national or regional attribute information of the target user to adapt to the local expression;

displaying the target descriptive information of at least one target product object on a designated webpage.

An apparatus for providing product object information, includes:
an original descriptive information determination unit, configured to determine at least one target product object to be provided to a target user and its original descriptive information;
a user attribute information determination unit, configured to determine the national or regional attribute information of the target user;
a localization processing unit, configured to process original descriptive information to adapt to local expression based on the target user's national or regional attribute information to generate target descriptive information;
an information provision unit, configured to provide the target descriptive information corresponding to the at least one target product object to the client corresponding to the target user, so that the target descriptive information is provided through a target page.

An apparatus for providing product object information, includes:

An information receiving unit, configured to receive target descriptive information of at least one target product object provided by the server for the target user, wherein the target descriptive information is generated by processing the original descriptive information of the target product object based on the national or regional attributes of the target user using local expression;

an information provision unit, configured to provide the target descriptive information of the at least one target product object on a designated webpage.

A computer-readable storage medium, storing a computer program, wherein the computer program includes instructions that, when executed by a processor, implement the steps of any of the preceding methods.

An electronic device, including:
one or more processors; and
a memory associated with the one or more processors, the memory configured to store program instructions, wherein the program instructions, when read and executed by the one or more processors, perform the steps of any of the preceding methods.

According to specific embodiments provided by the present application, the following technical effects are disclosed:

Through the embodiments of this application, when it is necessary to provide information about a target product object to a target user, the original descriptive information of the target product object and the national or regional attribute information of the target user can be obtained first. Then, based on the national or regional attribute information of the target user, the original descriptive information can be processed using local expression to generate target descriptive information. This target descriptive information can then be provided to the target user through a target page. In this way, the expression of the descriptive Information of the product object provided on the target page can achieve “customized experience for each individual” and better align with the localization preferences of the target user's country/region, thereby more easily stimulating the user's shopping enthusiasm, enhancing the user experience, and consequently improving metrics such as click-through rates and conversion rates.

In a preferred approach, the capabilities of AI (Artificial Intelligence) large-scale parameter models in multimodal content understanding, generation, and other aspects can be utilized to assist in the localization-based transformation of product descriptive information. This can improve efficiency and enhance the contextual coherence of the transformed textual content. Furthermore, to ensure higher usability and accuracy of the content generated by the AI large model, targeted training can be conducted in advance using specific samples and rules.

It should be understood that implementing any product of this application does not necessarily need to achieve all of the above-mentioned advantages simultaneously.

### BRIEF DESCRIPTION OF DRAWINGS

To more clearly illustrate the technical solutions in the embodiments of this application or the prior art, the drawings required for the embodiments will be briefly introduced below. It is evident that the drawings described below are merely some embodiments of this application. For those of ordinary skill in the art, other drawings can also be obtained based on these drawings without creative efforts.

FIG. 1 is a schematic diagram of the system architecture provided by the embodiments of this application;

FIG. 2 is a flowchart of the server-side method provided by the embodiments of this application;

FIG. 3 is a flowchart of the client-side method provided by the embodiments of this application;

FIG. 4 is a schematic diagram of the server-side device provided by the embodiments of this application;

FIG. 5 is a schematic diagram of the client-side device provided by the embodiments of this application;

FIG. 6 is a schematic diagram of the electronic device provided by the embodiments of this application.

### DESCRIPTION OF EMBODIMENTS

The technical solutions in the embodiments of this application will be clearly and completely described below in conjunction with the accompanying drawings. It is evident that the described embodiments are only a part of the embodiments of this application and not all of them. All other embodiments obtained by those of ordinary skill in the art based on the embodiments in this application fall within the scope of protection of this application.

Firstly, during the implementation of the embodiments of this application, the inventors discovered that in the current e-commerce field, “customized experience for each individual” are already quite mature. However, they primarily achieve personalization from the perspective of product matching. For different users, the front-end presentation of the same product remains consistent (including titles, description images, product introductions, etc., although there are methods for generating product images, they mainly highlight key benefits and are limited in usage scenarios). However, this “consistent” expression fails to ignite the shopping enthusiasm of different users, especially in the context of cross-border e-commerce, where cultural, habitual, and preference differences among users from different nationalities/regions are significant. If personalized localization is also applied to the front-end expression of product information, it can further enhance the user experience, thereby improving metrics such as click-through rates and conversion rates. For example, in terms of habitual terminology, “video” is referred to as [symbol] [Pinyin: shixun] in Hong Kong and [symbol] [symbol] [Pinyin: shipin] in mainland China; “orange” in mainland China is called [symbol] [Pinyin: liuding] in Taiwan; “power bank” is known as [symbol] [Pinyin: niaodai] in Hong Kong, etc. Additionally, in terms of visual presentation, users from different nationalities/regions have different preferences. For example, Brazilian users generally prefer vibrant and colorful compositions, while users in Europe and North America tend to prefer minimalist expressions; for example, shoe sizes are labeled as size 6 in the US, corresponding to size 235 in China and size 37 in Europe. Regarding product models, users in Asia are more accustomed to seeing Asian models who tend to have slimmer body types, whereas users in Europe and North America are more accustomed to seeing models from their regions, who tend to have fuller body types. These differences in expression significantly impact the user experience, and using matched expressions is more likely to gain local recognition.

Therefore, in the embodiments of this application, a corresponding solution is provided. In this solution, when determining the products to be recommended to the user, or when returning products that meet the search criteria based on the user's search request, the front-end expression of the product descriptive information can be transformed. This transformation makes the descriptive information more in line with the localization habits of the target user's national/region. The transformed descriptive information is then provided to the current target user through a target page, thereby giving the target user a more familiar and engaging experience.

Specifically, when transforming the front-end expression of the descriptive information, it may include the transformation of various modalities of descriptive information such as text information, attribute parameter information, and rich media information (including images, audio, etc.) into local expression that are more suitable for the user's location. In a preferred embodiment, the capabilities of AI (Artificial Intelligence) models and other related models can be utilized to achieve the localization transformation of multimodal product descriptive information. This ensures that the transformed descriptive information is more fluent and natural, avoiding issues like awkward sentences that can occur with simple keyword replacements. The processing efficiency is also higher, allowing the transformation process to be completed within a time frame of hundreds of milliseconds, thereby better supporting the implementation of the entire solution.

Since the solution provided by the embodiments of this application involves the transformation of various modalities of descriptive information through AI models, a brief introduction to the relevant concepts of AI models (especially AI large-scale parameter models, which will be mainly used as examples below) is necessary for better understanding. AI large-scale parameter models, also known as AI large models, refer to a class of foundation models. These models are characterized by a massive number of parameters trained using vast amounts of data, enabling them to adapt to a wide range of downstream tasks. For AI large-scale models, not only is there a characteristic of having a massive number of parameters (with the parameter count typically increasing exponentially from millions to billions, trillions, and even more as the models continue to iterate), but they also support multiple modalities. Initially, AI large models supported single tasks within single modalities such as images, text, speech, and video.

However, they have gradually evolved to support various tasks across multiple modalities. In other words, large models typically possess efficient understanding capabilities of multiple modalities, cross-modal perception abilities, and the ability to transfer and execute across diverse tasks. They may even exhibit multimodal information perception capabilities similar to those of the human brain.

From another perspective, AI large models are short for “Artificial Intelligence Pre-trained Large Models,” encompassing both “pre-training” and “large models.” The combination of these two aspects generates a new AI paradigm, where models, after being pre-trained on large-scale datasets, can support various downstream applications without fine-tuning or with only minimal fine-tuning. In other words, AI large models benefit from the “large-scale pre-training+fine-tuning” paradigm, enabling them to adapt well to different downstream tasks and demonstrating their powerful generality. This general-purpose capability of AI large models, with shared parameters, allows for superior performance in various downstream application scenarios with corresponding fine-tuning, overcoming the limitations of traditional AI models that struggle to generalize to other tasks.

From the perspective of processing results, the aforementioned AI large models also belong to a category of generative models. These models can not only predict results based on features but also “understand” how data is generated and use this understanding to “create” new data.

With the support of the aforementioned capabilities and existing knowledge of AI large models, the localization transformation of product descriptive information in the embodiments of this application can be better implemented. For example, the original descriptive information of the product and the national or regional attribute information of the current target user can be input into the AI large model. The AI large model can then perform corresponding keyword transformations, attribute/parameter information transformations, image transformations, and other processing. Additionally, for textual content, the model can handle local grammar expression habits based on the transformed keywords and other elements, ensuring contextual coherence. This makes the transformed text more in line with the local grammatical expression habits of the current target user and more fluent, avoiding issues such as awkward sentences that may arise from direct keyword replacement.

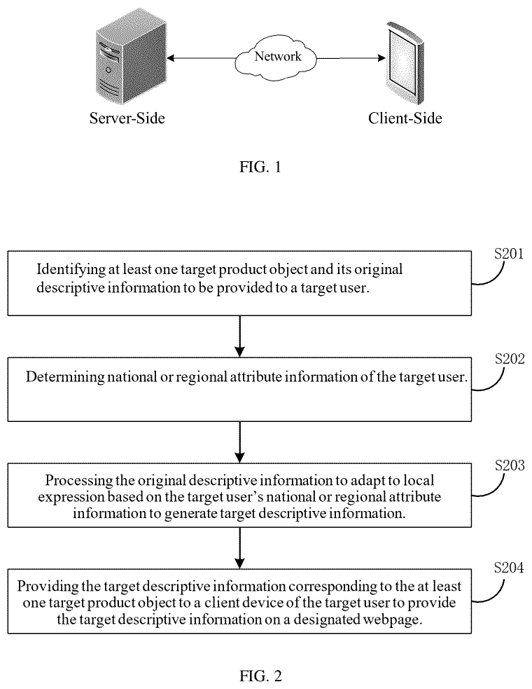

From the perspective of system architecture, referring to FIG. 1, the embodiments of this application can be implemented in a product information service system. The system may specifically include a client-side and a server-side. The client-side is primarily used for displaying front-end webpages and interacting with users, while the server-side is mainly responsible for providing specific data. In the embodiments of this application, specific AI models and related components can be stored on the server-side. After the transformation of descriptive information is performed, the transformed descriptive information is then returned to the client-side for display and further processing. Of course, in practical applications, the computational resources of both “edge+cloud” can be fully utilized. For some simple logic, the computational resources on the client-side can be used for edge-side computation, while more complex logic can be computed on cloud servers, etc.

The following is a detailed description of the specific implementation provided by the embodiments of this application.

### Embodiment One

Firstly, from the perspective of the server-side, the embodiment one provides a method for providing product object information refer to FIG. 2. This method may includes:

Step 201: identifying at least one target product object and its original descriptive information to be provided to a target user.

In the embodiments, the conversion of the local expression of product descriptive information can be applied in various scenarios. For example, one such scenario could be a product recommendation scenario. That is, when it is necessary to recommend products to the target user, at least one target product to be recommended can be determined based on the target user's historical behavior records, preferences, and other information (this process can already achieve “customized experience for each individual” at the product dimension). Then, when displaying the information of the recommended product on the page, it is also possible to process the information based on local expression, achieving “customized experience for each individual” at the level of product; alternatively, in a search scenario, when the user inputs keywords or images, at least one target product that meets the search criteria can be matched. In this case, in the search scenario, the existing technology can also achieve “customized experience for each individual” at the product dimension. Then, when displaying the information of such product search results on the page, it is also possible to process the information based on local expression, achieving “customized experience for each individual” at the level of product information expression. Additionally, when displaying the details of a specific product to the user, the specific descriptive information can undergo local expression conversion processing, etc. In other words, in the embodiments, the specific local expression conversion processing can be applied in various scenarios. Correspondingly, it can achieve “customized experience for each individual” at the frontend expression dimension of product descriptive information on various types of pages, such as the recommended product information flow page, the product search results page, and the product details information page.

Wherein the original descriptive information of the target product can be obtained from the product information database. Typically, this information is provided by the merchant when the product is listed, and includes the title, rich media information (including images, videos, audio, etc.), and attribute/parameter information. Additionally, the original descriptive information of the product may also include user reviews and other descriptive information. In summary, all the information that needs to be displayed on the specific page can be considered as the descriptive information to be converted. When performing the conversion processing, all of the descriptive information can be converted, or only a part of it can be converted, and so on.

It should be noted that in practical applications, the same target product may be associated with multiple different SKUs (Stock Keeping Units, the basic unit of inventory measurement). Although they may share the same detail page, each SKU typically has its own corresponding images, titles, and other descriptive information. For example, a clothing item may be available in three sizes—S, M, and L—and two colors—black and white. Before placing an order, users generally need to open the SKU selection interface through an option on the detail page (usually displayed as a half-screen overlay on the detail page) to select the specific size, color, and other attributes. For instance, if a user selects size S and color white, it indicates that the user intends to purchase the SKU with size S and color white. When displaying information for various SKUs through the SKU selection interface, different representative images may be provided for different SKUs. For example, in the aforementioned case, clothing items in different colors can each have their own respective images, etc. In the traditional method, when different users view this SKU selection interface, the displayed information is the same, including the images corresponding to the same SKU. However, in embodiments of the application, the descriptive information displayed in this SKU selection interface can also undergo local expression processing based on the national or regional of the current user. This ensures that users from different country/region see different descriptive information for the same SKU of the same product, as it has been processed according to the local expression methods of different country/region. Specifically, for the same SKU, this solution considers factors such as country and user information, and uses AI-generated methods to perform different localization or personalization processes. This includes converting keywords related to the product name and/or adjectives in the original textual content into commonly used local terms corresponding to the national or regional attributes. Alternatively, based on the attribute preferences of the population corresponding to the national or regional attributes for the category of the target product, the original title textual content can be converted to express product attributes. Additionally, based on the national or regional attributes of the target user, the original user review textual content can be reordered to prioritize the display of local user reviews corresponding to the national or regional attributes.

In summary, in the embodiments, it is also possible to obtain the original descriptive information corresponding to each SKU. Subsequently, during the localization process, the original descriptive information corresponding to these SKUs can be processed based on local expression. This ensures that users from different country/region see different target descriptive information for the same SKU. For example, the title, images, and other information of the SKU can undergo local expression processing. Specifically, in the aforementioned example of a clothing item available in black and white, each color corresponds to different SKU images. In embodiments of the application, if users A and B are in different country/region, even if both users view the “white” variant of the product, the SKU images displayed for “white” can be different, each having its own local expression.

Step 202: determining national or regional attribute information of the target user.

In addition to determining the original descriptive information of the product, the national or regional attributes of the specific target user can also be determined, including the specific country/region to which the target user belongs. This information can be determined in various ways, such as using the user's IP (Internet Protocol) address, frequently used shipping address, and other information to ascertain the user's country/region. Additionally, there are cases where users may live in a particular country/region but are originally from another country/region and retain their original habits. Therefore, the user's historical behavior records can also be used to determine their actual national or regional attributes. For example, if a user's IP address indicates they are in Country A, but their browsing history and shopping habits suggest they are more likely from Country B, then Country B can be used as the user's country/region attribute.

It should be noted that, in specific implementations, in addition to obtaining the user's national or regional attribute information, other user profile data can also be acquired. This includes information such as whether the user is male or female, and whether they are a young adult, middle-aged, or elderly. This user profile data can also be used to personalize the frontend descriptive information of the product from other dimensions.

Step 203: processing the original descriptive information to adapt to local expression based on the target user's national or regional attribute information to generate target descriptive information.

After determining the at least one target product and its original descriptive information, as well as the national or regional attributes of the target user, the original descriptive information can be localized based on these national or regional attributes to generate the target descriptive information.

The specific original descriptive information may include various modalities of information, such as text information, image information, attribute/parameter description, and so on. Different modalities of information can be processed separately, or only certain modalities of information can be processed.

Specifically, for text information, this may include the product title, text and image details on the product detail page, user review content, and other text-related information, all of which can be converted. Of course, for product listing pages (such as recommended product information flow pages or search result pages), there may not be text and image details or user reviews involved. Therefore, the conversion can be applied only to the title part, and so on.

Specifically, when performing conversion processing on text information, the original text information of the target product is localized based on the national or regional attributes of the target user to generate the target text to displayed on the target page.

When performing localization-based conversion of text information, the most basic conversion may include transforming keywords related to the product name and/or adjectives in the original text information into commonly used local terms corresponding to the national or regional attributes. For example, if the original title of a product includes the term [symbol] [Pinyin: Chengzi](orange), and the current target user is from Taiwan, the term [symbol] [Pinyin: Chengzi](orange) can be converted to “ [symbol] [symbol] ” (Pinyin: Liuding; “orange” in Taiwan's dialect). Similarly, if the original title includes the adjective [symbol] (Pinyin: Piaoliang; beautiful), and the current target user is from Hong Kong, [symbol] can be converted to [symbol] (Pinyin: Liang; “beautiful” in Hong Kong's dialect), and so on.

Additionally, during the conversion of the original title text information, there may be instances where the title text includes content related to the expression of product attributes. In such cases, besides converting keywords like nouns and adjectives into commonly used local terms, the textual content related to product attributes can also be converted based on the attribute preferences of the population corresponding to the national or regional attributes for the category of the target product. When converting textual content related to product attribute expression, various methods can be employed. For example, the target textual content related to product attribute expression in the original title text can be deleted or converted to other attribute values, or textual content related to product attribute expression can be added to the original title text, and so on.

For example, for a product like a “thermos cup,” to highlight its capacity feature, the title text might include specific parameter values like “500 ml.” However, users in some regions might prefer a “thermos cup” with a capacity of “375 ml.” If the product also has an SKU (Stock Keeping Unit) corresponding to “375 ml,” the attribute value “500 ml” in the title can be changed to “375 ml” when displaying the product information to users in that region. Similarly, for a product like a “power bank,” users in mainland China might be more interested in its “large capacity” feature, so the title might include an attribute value like “20000 mAh.” However, users in Hong Kong might not be as concerned with the capacity information. Therefore, if the target users are from Hong Kong, the “20000 mAh” attribute value can be removed from the title, and so on.

Additionally, specific text information can also include user review content. When performing conversion processing, besides converting keywords like nouns and adjectives into commonly used local terms, the original user review textual content can also be reordered based on the national or regional attributes of the target user. This prioritizes the display of local user review textual content that corresponds to the target user's national or regional attributes. In other words, in a cross-border e-commerce scenario, users reviewing the same product may come from different parts of the world. Reviews from users in the same or similar country/region as the current user may be more relevant to them. Therefore, in the embodiments, local user review textual content that corresponds to the national or regional attributes of the current target user can be prioritized. This ensures that when the target user views the user reviews of the target product, they can see these local user reviews first.

It should be noted that, in the process of performing localization-based conversion of text information, traditional methods can be used. For example, by collecting and analyzing data in advance, a correspondence vocabulary database of commonly used terms in different countries/regions can be established. This way, during the actual conversion process, keyword replacement can be performed by querying the vocabulary database. However, this method has high costs and the vocabulary database's scale and type are very limited. For instance, if a certain keyword does not have a corresponding commonly used term in the vocabulary database for a specific country/region, the conversion may not be achievable. Additionally, this simple keyword replacement method might result in text that lacks contextual coherence or produces grammatical expressions that do not match the syntax used in the target user's country/region.

To address the above issues, an AI large model can be utilized to achieve localization-based conversion of textual content in a preferred method. Specifically, some existing AI large models are extremely rich in content and knowledge, can understand “questions” expressed in natural language, and can generate new content based on specific questions. The newly generated textual content typically exhibits good coherence in context and other aspects. Therefore, in the preferred embodiment of this application, the original title text and the national or regional attribute information of the target user can be input into a AI large-scale parameter model. This AI model will perform the localization-based conversion of the original title text of the target product. Furthermore, the AI model can also process the converted textual content further. For example, based on the local expression method corresponding to the national or regional attribute information, the AI model can process the converted textual content to ensure it adheres to local grammatical expression habits and/or maintains contextual coherence, thereby generating the target textual content.

For some general AI large models, directly utilizing such a model for localization-based conversion of specific textual content relies entirely on the AI model's existing knowledge for content generation. In this case, there may be instances where the generated textual content is not sufficiently accurate. Therefore, in specific implementations, to ensure that the content generated by the AI large model is more suitable for the application scenarios of the embodiments, the AI large model can be pre-trained with targeted training. In other words, while the AI large model encompasses a wealth of content, effectively extracting valuable information for the scenarios described in the embodiments is crucial. This process ensures that the content ultimately generated by the AI large model has high credibility without requiring human intervention.

To achieve this objective, one approach during training is to input both positive and negative samples into the AI large model. These samples may include product titles and other textual content, along with their corresponding local conversion results for various countries/regions. By inputting these samples into the AI large model, the model can learn the specific “knowledge” required for the localization-based conversion process of textual content.

The aforementioned approach may involve a significant workload in constructing samples and high training costs. Therefore, in another approach, a more comprehensive vocabulary database encompassing richer information can be pre-built using the AI large model. This vocabulary database can then be used as input for the model. By utilizing this pre-constructed vocabulary database, the AI large model can perform conversion and other processing of specific textual content, thereby enhancing the usability of the content generated by the AI large model to a certain extent. Specifically, in the initial stages, small-scale dictionaries containing positive and negative samples of commonly used terms across multiple countries/regions can be prepared (for example, the correspondence between terms like “ [symbol] ” [Pinyin: Shipin](video) in mainland China and “ [symbol] [Pinyin: Shixun](video) in Hong Kong). These samples can be input into the AI large model. Additionally, certain rules can be established to address the unique localization requirements of specific countries/regions. For instance, in Hong Kong, the output should be in traditional Chinese, while in Taiwan, it should be in Hakka dialect, and so on. Additionally, key categories can be identified, and rules can be established based on these key categories. By inputting the aforementioned positive and negative samples along with the rules, the AI large model can be instructed not only to generate data but also to produce generalized results. This means that the AI large model can generalize based on the small-scale samples and rules provided. For example, if the sample includes the pair [symbol] [Pinyin: Chengzi](mainland China)— [symbol] [Pinyin: Liuding](Taiwan),” the model can search for all terms related to the category [symbol] [Pinyin: Chengzi] across the internet, identifying which terms are commonly used in different countries/regions. In this way, the AI large model can generalize based on a limited set of samples. The generalization process must also follow certain rules, which are specific to the scenarios described in the embodiments and input as relevant knowledge to the AI large model. In addition to building a more comprehensive vocabulary database for noun-related keywords, similar processing can be applied to adjective-related keywords. This enables the AI large model to perform localization-based conversion for adjectives as well.

Additionally, since there is usually a certain collocation relationship between nouns and adjectives, meaning not all nouns and adjectives can be used together, therefore, to achieve better results, tags can be added to specific nouns and adjectives based on their compatibility, specifying which combinations are permissible for word matching, and so on.

Furthermore, with the aforementioned samples and rules, the AI large model can also validate and score the content it produces. Through continuous optimization and training, the goal is to ensure that the content generated meets the usability requirements for the application scenarios described in the embodiments.

In the above method, since a more comprehensive vocabulary database has been generated offline, the process of localization-based conversion of textual content can be further refined. The original textual content, the national or regional attribute information of the current target user, and the offline-generated vocabulary database can be input into the AI large model. This enables the AI large model to replace keywords with commonly used local terms based on the vocabulary database. Additionally, the model can perform localization of grammatical expressions and ensure contextual coherence, among other things. In this way, since the vocabulary database has been generated offline in advance (and can be updated periodically), the AI large model can query the vocabulary database to obtain the specific target keywords that need to be replaced. Then, it only needs to handle aspects such as grammar and contextual coherence, thereby further improving content production efficiency and better meeting real-time requirements. If the vocabulary database does not contain commonly used terms for a particular country/region, the AI large model can also determine them by searching the entire web for knowledge, and so on.

Similarly, samples of attribute preference information and local grammatical expression habits corresponding to multiple countries/regions can also be input into the AI large model. This allows the AI large model to acquire knowledge related to attribute preferences and local grammatical expression habits, so that the model can perform local conversion of content related to attribute expressions in the text, make the final generated textual content aligns better with local expression habits in terms of grammar and other aspects. In this way, when it is necessary to convert the descriptive information of a certain product for a target user, the information input into the AI large model may include not only the original textual content and the national or regional attributes of the target user but also the pre-established knowledge base and/or rule information. The specific knowledge base may include local commonly used terms, attribute preference information, and/or local grammatical expression habits for multiple countries/regions. The specific rule information may include special localization requirements for certain countries/regions, and so on. The knowledge base can be generated offline by the AI large model, among other methods.

The conversion process for textual content has been introduced above. Another type of descriptive information is the attribute/parameter description of the product. In other words, the original descriptive information that needs to be converted may include attribute/parameter description. For example, for clothing products, attributes/parameters may include size and color. For appliances, attributes/parameters may include capacity and color, among others. Such attribute/parameter information often involves units of measurement, which can vary between countries/regions. For instance, commonly used sizes for products can differ significantly between regions, including shoe sizes, clothing sizes, weight, and so on. Specifically, a size 6 shoe in the US corresponds to a size 23.5 in China and a size 37 in Europe, among others. Therefore, based on the national or regional attributes of the target user, the original attribute/parameter description of the target product can undergo localization-based conversion processing. This generates the target attribute/parameter description, which can then be displayed on the target page.

When converting attribute/parameter description, one approach is to use the national or regional attributes of the target user to convert the original attribute/parameter description of the target product into local standards or units. For example, if a shoe's original “size” attribute is expressed as 36, 37, 38 in European sizes, it can be converted to 5, 5.5, 6 in US sizes for American users, and so on.

On the other hand, if the target product is associated with multiple SKUs corresponding to different attribute/parameter values, these SKUs can be reordered to prioritize the display of SKUs with local commonly used attribute/parameter values corresponding to the national or regional attributes of the user. For example, for a “baby bottle” product with a “capacity” attribute including different values such as 500 ml and 375 ml, corresponding to different SKUs, the default display might prioritize the 500 ml SKU. However, for users in Hong Kong, where 350 ml is a more preferred capacity, the 350 ml SKU can be prioritized. Similarly, for certain electrical products with SKUs supporting various voltage values such as 110V and 220V, the default display might prioritize the 220V SKU. However, for users in countries/regions like Japan, the 110V SKU can be prioritized, and so on.

When performing localization-based conversion of a product's attribute/parameter description, traditional methods can be used. Alternatively, the original attribute/parameter description and the national or regional attributes of the target user can be input into a AI large-scale parameter model. This model can then perform localization-based conversion of the original attribute/parameter description of the target product. To enable the AI model to perform more accurate conversion of attribute/parameter-related descriptive information, the model can be pre-trained with targeted training. Additionally, knowledge about how different countries/regions commonly express various attributes across different dimensions can be input into the AI model. This allows the AI model to generate more usable content.

In addition to textual content and attribute/parameter description, specific product descriptive information can also include rich media information, such as images and audio. This means that the original descriptive information requiring conversion can also include rich media information of the product, such as pictures, videos, and audio. Therefore, based on the national or regional attributes of the target user, the original rich media information of the target product can undergo localization-based conversion processing to generate target rich media information. The target rich media information can then be displayed on the designated webpage.

When processing image information, localization-based conversion may include adjustments to the composition style, type of models used, and/or atmospheric elements in the images. Specifically, when processing image information, localization-based conversion may include adjustments to the composition style, type of models used, and/or atmospheric elements in the images. Product compositions can be regenerated based on local preferences. For example, users in Brazil tend to prefer vibrant and colorful compositions, while users in Europe and North America prefer minimalist styles. Therefore, the composition style of images can be adjusted according to the preferences of users in different countries/regions. Regarding model types, there are significant body type differences between the U.S./European and Asian users. Asian users may prefer models with a fresh, slim look, while the U.S. and European users might prefer fuller-figured models. Additionally, since users in the U.S. and European regions generally have fuller body types, using models that match this body type can enhance the user's sense of connection with the product. Regarding atmospheric elements in images, these are typically added to create a certain mood or ambiance. However, some elements may be sensitive for users in certain countries/regions. For example, “watermelon” might be a sensitive element for African users, particularly African American users. Therefore, these atmospheric elements can also be adjusted by removing or replacing sensitive elements with other elements.

When performing localization-based conversion of image content, this can also be achieved through a AI large-scale parameter model. Specifically, the AI model can handle tasks such as subject recognition, image extraction, and replacement. For example, the process of converting model types can be handled by the AI model generating appropriate model images based on the target user's country/region. These new model images can then be matched with the current product images to create new product images. For instance, if an image originally features an Asian model wearing a dress, the model can be replaced with one that has the typical appearance and body type of users in the U.S. and European regions when displaying the product to the U.S. and European users. The dress image can be adjusted to fit the new model's body shape. Finally, the new model image can be combined with specific background images and atmospheric elements to generate the final target image.

It should be noted that the converted model images can be virtual model figures created by the AI large model. To enhance processing efficiency, representative virtual model images for certain countries/regions can be generated offline in advance. During the conversion process, a suitable virtual model image can be selected from these pre-saved images, and the specific product image can be matched to this virtual model. Each country/region can have multiple different virtual model images. This allows for the use of different virtual model images with different product images on a page containing multiple products, thereby avoiding the scenario where multiple products on the same page feature the same virtual model image.

Additionally, when matching product images with virtual model images, the specific attributes/parameters of the product should be considered. For example, some clothing materials might lack elasticity, or the sizes might run small, making them unsuitable for fuller-figured the U.S. and European users. In such cases, it may be unnecessary to replace the model with one that represents the U.S. and European users, thereby avoiding potential consumer confusion or misleading information. In practice, if the AI large model is used for model conversion, the specific attributes/parameters of the product can also be input into the AI model. This allows the AI model to make a comprehensive decision and output the appropriate conversion result.

If the original descriptive information of the specific product also includes audio information, such as background music in videos, this audio information can also undergo localization-based conversion. For example, if the target users are from India, the background music of the product can be replaced with audio that reflects the style of the Indian region, and so on.

Step 204: providing the target descriptive information corresponding to the at least one target product to a client device of the target user to provide the target descriptive information on a designated webpage.

After the local expression conversion processing of the textual content, attribute/parameter description, multimedia information, etc. of the target product object, it can be returned to the corresponding client of the target user. The client provides it to the target user through a specific designated webpage. The specific designated webpage can be a recommended product information stream page, a product search results page, a product detail page, etc.

In summary, through the embodiments of this application, when it is necessary to provide information about a target product object to a target user, the original descriptive information of the target product object and localization attribute information of the target user can be first obtained. Then, based on the national or regional attribute information of the target user, the original descriptive information can be processed for local expression to generate the target descriptive information to be provided to the target user through the designated webpage. By this means, it is possible to achieve a “customized experience for each individual” in the expression of the product object descriptive information provided on the designated webpage, making it more in line with the localization preferences of the target user's country/region. This approach is more likely to stimulate the user's shopping enthusiasm, enhance the user experience, and consequently improve metrics such as click-through rates and conversion rates.

In a preferred method, the capabilities of AI large-scale parameter models in multimodal content understanding and generation can be utilized to help complete the local expression conversion of product descriptive information. This can improve efficiency and enhance the contextual coherence of the converted textual content. Of course, to ensure the higher usability and accuracy of the content generated by the AI large model, it is also possible to pre-train the AI model using specific samples, rules, and other methods.

### Embodiment Two

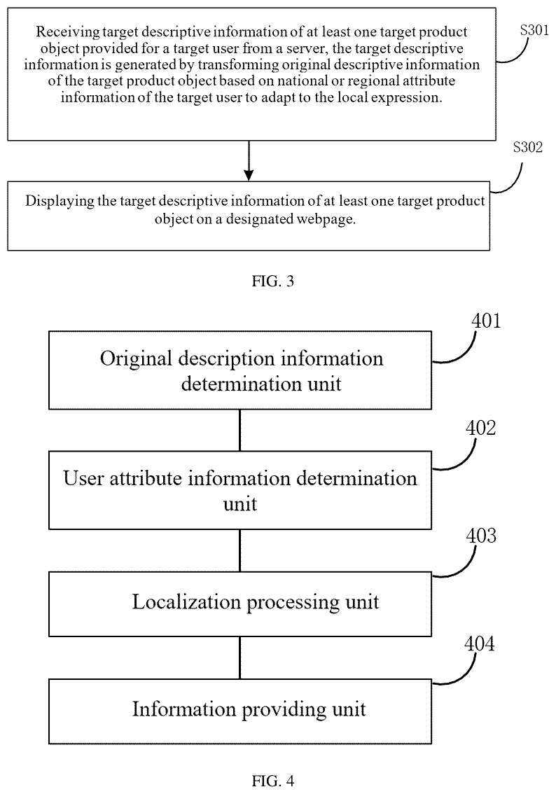

Embodiment two corresponds to the embodiment one. From the perspective of the client, it provides a method for providing product object information. Refer to FIG. 3. The method may specifically include:

step301: receiving target descriptive information of at least one target product object provided for a target user from a server, where the target descriptive information is generated by transforming original descriptive information of the target product object based on national or regional attribute information of the target user to adapt to the local expression;

step302: displaying the target descriptive information of at least one target product object on a designated webpage.

For the parts not detailed in the embodiment two, one can refer to the descriptives in embodiment one or other parts of this specification, which will not be repeated here.

It should be noted that the embodiments of this application may involve the use for user data. In practical applications, user-specific personal data can be used in the solutions described herein in compliance with applicable laws and regulations of the relevant country (e.g., with explicit user consent, proper user notification, etc.), and within the permissible scope of such laws and regulations.

Corresponding to embodiment one, this application embodiment also provides a device for providing product object information. Referring to FIG. 4, the device may include:
An original descriptive information determination unit 401, configured to identify at least one target product object and its original descriptive information to be provided to a target user;
a user attribute information determination unit 402, configured to determine national or regional attribute information of the target user;
a localization processing unit 403, configured to process the original descriptive information to adapt to local expression based on the target user's national or regional attribute information to generate target descriptive information;
an information providing unit 404, configured to provide the target descriptive information corresponding to the at least one target product object to a client device of the user to provide the target descriptive information on a designated webpage.

Specifically, the localization processing unit can be utilized for:
utilizing an artificial intelligence (AI) large-scale parameter model to understand the original descriptive information, and processing the original descriptive information based on the national or regional attribute information of the user for local expression to generate the target descriptive information.

The original descriptive information includes: the original textual content of the target product object;

in this instance, the localization processing unit can be specifically utilized for:
conducting localization expression conversion processing on the original textual content of the target product object based on the national or regional attribute information of the user to generate the target textual content, so that the target textual content can be displayed on the designated webpage.

Specifically, the keywords related to the product name and/or adjectives included in the original textual content can be converted into local common terms corresponding to the national or regional attribute information.

The original textual content includes: the original title textual content;

in this instance, the localization processing unit can also be specifically utilized for:
conducting conversion processing of the original title textual content related to the expression of product attributes, based on the attribute preference information of the demographic corresponding to the national or regional attribute information for the category of goods to which the target product object belongs.

Specifically, the original title textual content related to the expression of product attributes can be deleted, converted to other attribute values, or additional textual content related to the expression of product attributes can be added to the original title textual content.

Alternatively, the original textual content includes: the original user review textual content;

in this instance, the localization processing unit can also be specifically utilized for:
reordering the original user review textual content based on the national or regional attribute information of the target user, so that local user review textual content corresponding to the national or regional attribute information is prioritized for display.

Specifically, the localization processing unit can be specifically utilized for:
inputting the original textual content and the national or regional attribute information of the user into an AI large-scale parameter model, so that the AI large-scale parameter model can perform localization expression conversion processing on the original textual content of the target product object;
the AI large-scale parameter model is also used to process the converted textual content according to the localization expression style corresponding to the national or regional attribute information, ensuring compliance with local grammatical expression habits and/or contextual coherence, to generate the target textual content.

Inputting the information into the AI large-scale parameter model can also include: a pre-established knowledge base and/or rule information, where the knowledge base includes local common terms, attribute preference information, and/or local grammatical expression habits for multiple countries/regions. The rule information includes specific localization requirements for certain countries/regions.

Additionally, the original descriptive information includes: the original attribute/parameter description of the target product object;

in this instance, the localization processing unit can be specifically utilized for:
conducting localization expression conversion processing on the original attribute/parameter description of the target product object based on the national or regional attribute information of the user to generate the target attribute/parameter description, so that the target attribute/parameter description can be displayed on the designated webpage.

Specifically, based on the national or regional attribute information of the user, the original attribute/parameter description of the target product object can be converted into local commonly used standards or units.

Alternatively, if the target product object is associated with multiple Stock Keeping Units (SKU) having different attribute values/parameter values, reordering these SKUs so that the SKUs corresponding to the local commonly used attribute values/parameter values based on the national or regional attribute information are prioritized for display.

Specifically, the localization processing unit can be specifically utilized for:
inputting the original attribute/parameter description and the national or regional attribute information of the user into the AI large-scale parameter model, so that the AI large-scale parameter model can perform localization expression conversion processing on the original attribute/parameter description of the target product object.

Additionally, the original descriptive information includes: the original m rich media information of the target product object;

in this instance, the localization processing unit can be specifically utilized for:
conducting localization expression conversion processing on the original rich media information of the target product object based on the national or regional attribute information of the user to generate the target multimedia information, so that the target rich media information can be displayed on the designated webpage.

Specifically, the original multimedia information includes the original image information;

in this instance, the localization processing unit can be specifically utilized for:
conducting conversion processing on the composition style, model types, and/or atmospheric elements of the original image information based on the national or regional attribute information of the user to generate target image information that aligns with the localization preferences corresponding to the national or regional attribute information.

Specifically, the original image information and the national or regional attribute information of the user can be input into the AI large-scale parameter model, so that the AI large-scale parameter model can conduct conversion processing on the composition style, model types, and/or atmospheric elements of the original image information.

When conducting conversion processing on the model types in the original image information, it can be determined whether to perform the conversion based on the attribute/parameter information of the target product object.

Additionally, the original multimedia information may include the original audio information;

in this instance, the localization processing unit can be specifically utilized for:
conducting conversion processing on the original audio information based on the national or regional attribute information of the user to generate target audio information that aligns with the localization preferences corresponding to the national or regional attribute information.

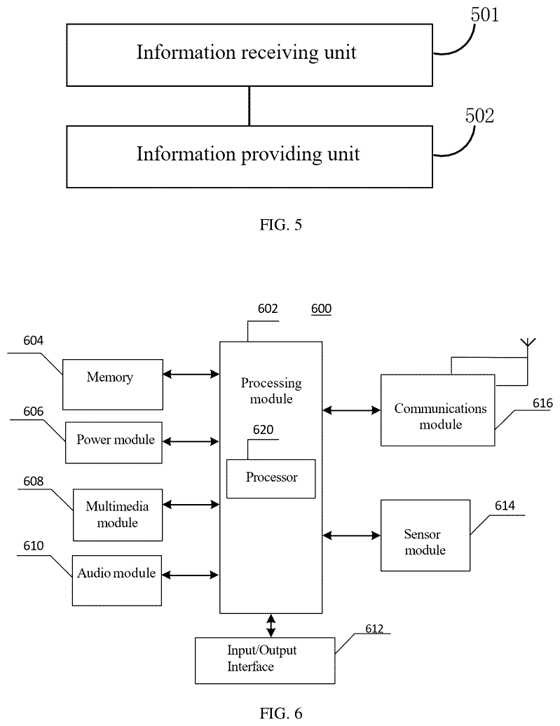

Corresponding to embodiment two, this application embodiment also provides a device for providing product object information. Referring to FIG. 5, the device may include:

an information receiving unit 501, configured to receive the target descriptive information of at least one target product object provided for the target user by the server. The target descriptive information is generated by processing the original descriptive information of the target product object based on the national or regional attribute information of the user for local expression;

an information providing unit 502, configured to provide the target descriptive information of the at least one target product object through the designated webpage.

Additionally, the embodiments of this application also provide a computer-readable storage medium with a computer program stored on it. When executed by a processor, the program implements the steps of any of the methods described in the aforementioned embodiments.

An electronic device is provided, comprising: one or more processors; and

a memory associated with the one or more processors, the memory being used to store program instructions. When the program instructions are read and executed by the one or more processors, they perform the steps of any of the methods described in the aforementioned method embodiments.

FIG. 6 exemplarily shows the architecture of an electronic device. For example, device 600 can be a mobile phone, computer, digital broadcasting terminal, messaging device, gaming console, tablet device, medical device, fitness equipment, personal digital assistant, aircraft, and so on.

Referring to FIG. 6, device 600 may include one or more of the following modules: a processing module 602, a memory 604, a power module 606, a multimedia module 608, an audio module 610, an input/output (I/O) interface 612, a sensor module 614, and a communications module 616.

The processing module 602 generally controls the overall operation of the device 600, such as operations associated with display, phone calls, data communication, camera operation, and recording. The processing module 602 may include one or more processors 620 to execute instructions to complete all or part of the steps of the methods provided by the present disclosure. Additionally, the processing module 602 may include one or more modules to facilitate interaction between the processing module 602 and other modules. For example, the processing module 602 may include a multimedia module to facilitate interaction between the multimedia module 608 and the processing module 602.

The memory 604 is configured to store various types of data to support the operation of the device 600. Examples of such data include instructions for any applications or methods operating on the device 600, contact data, phonebook data, messages, pictures, videos, and more. The memory 604 can be implemented by any type of volatile or non-volatile storage device, or a combination of these, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power module 606 provides power to various modules of the device 600. The power module 606 may include a power management system, one or more power supplies, and other modules associated with generating, managing, and distributing power for the device 600.

The multimedia module 608 includes a screen that provides an output interface between the device 600 and the user. In some embodiments, the screen may include a liquid crystal display (LCD) and a touch panel (TP). If the screen includes a touch panel, it can be implemented as a touchscreen to receive input signals from the user. The touch panel includes one or more touch sensors to sense touches, swipes, and gestures on the touch panel. The touch sensors can detect not only the boundaries of touch or swipe actions but also the duration and pressure associated with the touch or swipe operations. In some embodiments, the multimedia module 608 includes a front camera and/or a rear camera. When the device 600 is in an operating mode, such as a shooting mode or a video mode, the front camera and/or rear camera can receive external multimedia data. Each front and rear camera can be a fixed optical lens system or have focal length and optical zoom capabilities.

The audio module 610 is configured to output and/or input audio signals. For example, the audio module 610 includes a microphone (MIC) that is configured to receive external audio signals when the device 600 is in an operating mode, such as a call mode, recording mode, or voice recognition mode. The received audio signals can be further stored in the memory 604 or transmitted via the communications module 616. In some embodiments, the audio module 610 also includes a speaker for outputting audio signals.

The I/O interface 612 provides an interface between the processing module 602 and peripheral interface modules, which may include a keyboard, click wheel, buttons, and other controls. These buttons can include but are not limited to: a home button, volume buttons, a power button, and a lock button.

The sensor module 614 includes one or more sensors that provide various state assessments for the device 600. For example, the sensor module 614 can detect the open/closed state of the device 600, the relative positioning of modules such as the display and keypad of the device 600, and changes in the position of the device 600 or one of its modules. The sensor module 614 can also detect the presence or absence of contact between the user and the device 600, the orientation, acceleration/deceleration, and temperature changes of the device 600. The sensor module 614 may include a proximity sensor configured to detect the presence of nearby objects without any physical contact. It may also include light sensors, such as CMOS or CCD image sensors, for use in imaging applications. In some embodiments, the sensor module 614 may also include an accelerometer, gyroscope sensor, magnetometer, pressure sensor, or temperature sensor.

The communications module 616 is configured to facilitate wired or wireless communication between the device 600 and other devices. The device 600 can access wireless networks based on communication standards such as Wi-Fi, or mobile communication networks like 2G, 3G, 4G/LTE, and 5G. In an exemplary embodiment, the communications module 616 receives broadcast signals or broadcast-related information from an external broadcast management system via a broadcast channel. In another exemplary embodiment, the communications module 616 also includes a Near Field Communication (NFC) module to facilitate short-range communication. For example, the NFC module can be implemented based on technologies such as Radio Frequency Identification (RFID), Infrared Data Association (IrDA), Ultra-Wideband (UWB), Bluetooth (BT), and other technologies.

In an exemplary embodiment, the device 600 can be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic modules to perform the aforementioned methods.

In an exemplary embodiment, a non-transitory computer-readable storage medium containing instructions is also provided, such as the memory 604 containing instructions that can be executed by the processor 620 of the device 600 to perform the methods provided by the present disclosure. For example, the non-transitory computer-readable storage medium can be ROM, random access memory (RAM), CD-ROM, magnetic tape, floppy disk, optical data storage devices, and the like.

From the description of the above embodiments, it can be understood by those skilled in the art that the present application can be implemented by means of software combined with the necessary general hardware platform. Based on this understanding, the technical solutions of the present application, or the parts contributing to the prior art, can be embodied in the form of a software product. This computer software product can be stored in a storage medium such as ROM/RAM, magnetic disk, optical disk, etc., and includes several instructions to enable a computer device (which can be a personal computer, server, or network device, etc.) to execute the methods described in various embodiments or certain parts of the embodiments of the present application.

The various embodiments in this specification are described in a progressive manner. The similar and identical parts of each embodiment refer to each other. Each embodiment focuses on the differences from the other embodiments. In particular, for systems or system embodiments, the description is relatively simple because they are fundamentally similar to the method embodiments. The relevant parts can be referred to in the method embodiments. The systems and system embodiments described above are merely illustrative. The units described as separate components may or may not be physically separate, and the components shown as units may or may not be physical units. They can be located in one place or distributed across multiple network units. Parts or all of the modules can be selected according to actual needs to achieve the objectives of embodiments. Those skilled in the art can understand and implement it without creative effort.

The methods and electronic devices for providing product object information provided by this application have been described in detail above. Specific examples have been used herein to illustrate the principles and embodiments of this application. The descriptions of the above embodiments are merely to aid in understanding the methods and core ideas of this application. For those skilled in the art, variations in the specific implementations and application ranges can be made based on the ideas of this application. In summary, the contents of this specification should not be construed as limiting this application.

What is claimed is:

1. A method for providing product objects information comprising:
identifying at least one target product object and its original descriptive information to be provided to a target user;
determining national or regional attribute information of the target user;
processing the original descriptive information to adapt to local expression based on the target user's national or regional attribute information to generate target descriptive information;
providing the target descriptive information corresponding to the at least one target product object to a client device of the target user to provide the target descriptive information on a designated webpage.

2. The method according to claim 1, wherein the processing the original descriptive information to adapt to the local expression based on the target user's national or regional attribute information to generate the target descriptive information comprises:
utilizing an artificial intelligence (AI) large-scale parameter model to comprehend the original descriptive information, and
processing the original descriptive information to adapt to the local expression based on the national or regional attribute information of the target user to generate the target descriptive information.

3. The method according to claim 1, wherein:
the target product object is associated with multiple Stock Keeping Units (SKUs); and wherein the processing the original descriptive information to adapt to the local expression based on the target user's national or regional attribute information to generate the target descriptive information comprises:
processing the original descriptive information corresponding to the SKUs to adapt to local expression to generate the target descriptive information, thereby to provide different target descriptive information for the same SKU to users with different national or regional attribute information, based on various local expression.

4. The method according to claim 1, wherein:
the original descriptive information comprises original textual content of the target product object; and
wherein the processing the original descriptive information to adapt to the local expression based on the target user's national or regional attribute information to generate the target descriptive information comprises:
transforming the original textual content of the target product object based on the national or regional attribute information of the target user to adapt to the local expression to generate target textual content for display on the designated webpage.

5. The method according to claim 4, wherein the transforming the original textual content of the target product object based on the national or regional attribute information of the target user to adapt to the local expression comprises:
converting keywords related to a product name and/or adjectives included in the original textual content into local common terms corresponding to the national or regional attribute information.

6. The method according to claim 4, wherein the original textual content comprises original title textual content; and wherein the transforming the original textual content of the target product object based on the national or regional attribute information of the target user to adapt to the local expression comprises:
processing the original title textual content to adapt to a textual content related to an expression of product attributes based on attribute preferences of a demographic corresponding to the national or regional attribute information for an category of products to which the target product object belongs.

7. The method according to claim 4, wherein the original textual content comprises an original user review textual content; and wherein the transforming the original textual content of the target product object based on the national or regional attribute information of the target user to adapt to the local expression comprises:
reordering the original user review textual content based on the national or regional attribute information of the target user, in order to prioritize the display of local user reviews according to the national or regional attribute information.

8. The method according to claim 4, wherein the transforming the original textual content of the target product object based on the national or regional attribute information of the target user to adapt to the local expression comprises:
inputting the original textual content and the national or regional attribute information of the target user into an AI large-scale parameter model, so that the AI large-scale parameter model performs the transforming the original textual content of the target product object based on the national or regional attribute information of the target user to adapt to into the local expression;
the AI large-scale parameter model is also used to adapt the transformed textual content to conform to local grammatical expression and/or local contextual coherence style based on the local expression corresponding to the national or regional attribute information, to generate the target textual content.

9. The method according to claim 1, wherein the original descriptive information comprises an original attribute/parameter description of the target product object; and wherein the processing the original descriptive information to adapt to the local expression based on the target user's national or regional attribute information to generate the target descriptive information comprises:
transforming the original attribute/parameter description of the target product object based on the national or regional attribute information of the target user to adapt to the local expression to generate target attribute/parameter description, for display on a designated webpage.

10. The method according to claim 9, wherein the transforming the original attribute/parameter description of the target product object based on the national or regional attribute information of the target user to adapt to the local expression comprises:
if the target product object is associated with multiple Stock Keeping Units (SKUs) having different attribute values/parameter values, reordering the SKUs to prioritize the display of the SKUs with locally commonly used attribute values/parameter values, corresponding to the national or regional attribute information.

11. The method according to claim 9, wherein the transforming the original attribute/parameter description of the target product object based on the national or regional attribute information of the target user to adapt to the local expression comprises:
inputting the original attribute/parameter description information and the national or regional attribute information of the target user into an AI large-scale parameter model, so that the AI large-scale parameter model performs the transforming the original attribute/parameter description of the target product object based on the national or regional attribute information of the target user to adapt to into the local expression.

12. The method according to claim 1, wherein the original descriptive information comprises original rich media information of the target product object; and
wherein the processing the original descriptive information to adapt to the local expression based on the target user's national or regional attribute information to generate the target descriptive information comprises:
transforming the original rich media information of the target product object based on the national or regional attribute information of the target user to adapt to the local expression to generate target rich media information, for display on the designated webpage.

13. The method according to claim 12, wherein the original rich media information comprises original image information; and wherein the transforming the original rich media information of the target product object based on the national or regional attribute information of the target user to adapt to the local expression comprises:
transforming composition style, model type, and/or atmospheric elements of the original image information based on the national or regional attribute information of the target user, to generate target image information that aligns with local preferences corresponding to the national or regional attribute information.

14. The method according to claim 12, wherein the original rich media information comprises original audio information; and
wherein the transforming the original rich media information of the target product object based on the national or regional attribute information of the target user to adapt to the local expression comprises:
transforming the original audio information based on the national or regional attribute information of the target user, to generate target audio information that aligns with local preferences corresponding to the national or regional attribute information.

15. A method for providing product object information, comprising:
receiving target descriptive information of at least one target product object provided for a target user from a server, the target descriptive information is generated by transforming original descriptive information of the target product object based on national or regional attribute information of the target user to adapt to the local expression;
displaying the target descriptive information of at least one target product object on a designated webpage.

16. An electronic device, comprising: one or more processors; and
one or more computer-readable memories coupled to the one or more processors and having instructions stored thereon that are executable by the one or more processors to perform one or more operations comprising:
identifying at least one target product object and its original descriptive information to be provided to a target user;
determining national or regional attribute information of the target user;
processing the original descriptive information to adapt to local expression based on the target user's national or regional attribute information to generate target descriptive information;
providing the target descriptive information corresponding to the at least one target product object to a client device of the target user to provide the target descriptive information on a designated webpage.

17. The electronic device according to claim 16, wherein the processing the original descriptive information to adapt to the local expression based on the target user's national or regional attribute information to generate the target descriptive information comprises:
utilizing an artificial intelligence (AI) large-scale parameter model to comprehend the original descriptive information, and
processing the original descriptive information to adapt to the local expression based on the national or regional attribute information of the target user to generate the target descriptive information.

18. The electronic device according to claim 16, wherein:
the target product object is associated with multiple Stock Keeping Units (SKUs); and wherein the processing the original descriptive information to adapt to the local expression based on the target user's national or regional attribute information to generate the target descriptive information comprises:
processing the original descriptive information corresponding to the SKUs to adapt to local expression to generate the target descriptive information, thereby to provide different target descriptive information for the same SKU to users with different national or regional attribute information, based on various local expression.

19. The electronic device according to claim 16, wherein:
the original descriptive information comprises original textual content of the target product object; and
wherein the processing the original descriptive information to adapt to the local expression based on the target user's national or regional attribute information to generate the target descriptive information comprises:
transforming the original textual content of the target product object based on the national or regional attribute information of the target user to adapt to the local expression to generate target textual content for display on the designated webpage.

20. The electronic device according to claim 19, wherein the transforming the original textual content of the target product object based on the national or regional attribute information of the target user to adapt to the local expression comprises:
converting keywords related to a product name and/or adjectives included in the original textual content into local common terms corresponding to the national or regional attribute information.
